(19) United States
(12) Patent Application Publication
(10) Pub. No.: US 2026/0331399 A1
(43) Pub. Date: Oct. 22, 2026

(54) BUTTON-TYPE CONNECTION DEVICE

(71) Applicants: NEXTRONICS ENGINEERING CORP., New Taipei City (TW); MAKALOT INDUSTRIAL CO., LTD., Taipei City (TW)

(72) Inventors: HOU-AN SU, KEELUNG CITY (TW); KUAN-WEN CHEN, NEW TAIPEI CITY (TW); YU-TING SUN, Keelung City (TW); WEI-YI TSAI, Taipei City (TW); LI-XIANG LEE, Taipei City (TW); HANG-SHOU SHEU, Taipei City (TW)

(21) Appl. No.: 19/369,312

(22) Filed: Oct. 26, 2025

(30) Foreign Application Priority Data
Apr. 21, 2025 (TW) 114114888

(51) Int. Cl. H01H 13/81; H01R 4/60

(52) U.S. Cl. CPC H01H 13/81; H01R 4/60

(57) ABSTRACT

A button-type connection device includes two button sets. Each of the two button sets includes a substrate and multiple buttons. The buttons are disposed on the substrate, and are connected by at least one wire. A connection member is disposed between a first member and a second member of one of the buttons of one of the two button sets, and the connection member includes a gasket and a slot portion, so that the button functions as a connector. A terminal is disposed at one end of a wire of another one of the two button sets. The terminal and the connection member cooperate with each other to outwardly transmit an electrical signal. Through a connection terminal formed by the terminal and the connection member, the terminal can be used for connection in subsequent processes. Accordingly, the two button sets are connectable and retain a bending property.

### CROSS-REFERENCE TO RELATED PATENT APPLICATION

This application claims the benefit of priority to Taiwan Patent Application No. 114114888, filed on Apr. 21, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a button-type connection device, and more particularly to a connection device used to connect a button set.

### BACKGROUND OF THE DISCLOSURE

A far infrared blanket can instantly heat up, store heat, help inducing sleep, and provide a comfortable sleeping experience. A plurality of buttons can be set on the far infrared blanket, and these buttons are connected with wires that can be used to transmit electrical signals. Since the buttons are arranged on the same substrate, a complete replacement is required when some of the buttons are damaged, thereby resulting in increased costs. In addition, since the buttons are arranged on the same substrate, bending thereof is not convenient. If the buttons are to be arranged separately, electrical connection issues will also arise.

### SUMMARY OF THE DISCLOSURE

In response to the above-referenced technical inadequacies, the present disclosure provides a button-type connection device. The button-type connection device can quickly connect two button sets, facilitate connection of the two button sets, and retain a bending property. The button sets are modularly designed, and can be disposed separately. When some of the button sets are damaged, these button sets can be replaced individually, thereby reducing maintenance costs. The button-type connection device can be easily bent and disposed on items that need to be bent, thereby having improved applicability.

In order to solve the above-mentioned problems, one of the technical aspects adopted by the present disclosure is to provide a button-type connection device. The button-type connection device includes two button sets, and each of the two button sets includes a substrate and a plurality of buttons. The plurality of buttons are disposed on the substrate, and the plurality of buttons of each of the two button sets are connected by at least one wire. Each of the plurality of buttons has a first member and a second member, and the first member and the second member are combined to be fixed on the substrate. A connection member is disposed between the first member and the second member of at least one of the plurality of buttons of at least one of the two button sets, the connection member is electrically conductive, and the connection member includes a gasket and a slot portion. The gasket and the slot portion are connected to each other, and the gasket is electrically connected to the first member and the second member. A terminal is disposed at one end of the at least one wire of at least another one of the two button sets, the terminal is in contact and conduction with the at least one wire, and the terminal is inserted into the slot portion to be in contact and conduction with the connection member, so that the two button sets achieve electrical connection.

In one of the possible or preferred embodiments, one end of the slot portion is connected to an outer edge of the gasket, and the slot portion is bent and extends to have a cylindrical shape. Another end of the slot portion is a free end, and has a snap portion. A snap hole is formed on the slot portion near the one end, and the snap portion is snapped into the snap hole.

In one of the possible or preferred embodiments, a contact arm is disposed on the slot portion, the contact arm is inclined toward an inside of the slot portion, and the contact arm abuts against the terminal.

In one of the possible or preferred embodiments, the terminal has a terminal body, and the terminal body is a hollow cylinder for accommodating the at least one wire. One end of the terminal body is connected to a stopper, an outer diameter of the stopper is larger than an outer diameter of the terminal body, the terminal body is inserted into the slot portion, and the stopper abuts against and is positioned at one end of the slot portion.

One of the beneficial effects of the present disclosure lies in that, the button-type connection device provided by the present disclosure includes two button sets, and each of the two button sets includes a substrate and a plurality of buttons. The plurality of buttons are disposed on the substrate, and the plurality of buttons of each of the two button sets are connected by at least one wire. Each of the plurality of buttons has a first member and a second member, and the first member and the second member are combined to be fixed on the substrate. A connection member is disposed between the first member and the second member of at least one of the plurality of buttons of at least one of the two button sets. The connection member includes a gasket and a slot portion. The gasket is electrically connected to the first member and the second member. A terminal is disposed at one end of the at least one wire of at least another one of the two button sets, the terminal is in contact and conduction with the at least one wire, and the terminal is inserted into the slot portion to be in contact and conduction with the connection member, so that the at least one wire can be electrically connected to the button through the terminal, and the two button sets achieve electrical connection. The button-type connection device of the present disclosure can quickly connect the two button sets, facilitate connection of the two button sets, and retain a bending property. The button sets are modularly designed, and can be disposed separately. When some of the button sets are damaged, these button sets can be replaced individually, thereby reducing maintenance costs. The button-type connection device can be easily bent and disposed on items that need to be bent, thereby having improved applicability.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a button-type connection device in a disassembled state according to one embodiment of the present disclosure;

FIG. 2 is a schematic view of the button-type connection device in an assembled state according to one embodiment of the present disclosure;

FIG. 3 is a perspective exploded view of a button and a wire according to one embodiment of the present disclosure;

FIG. 4 is another perspective exploded view of the button and the wire according to one embodiment of the present disclosure;

FIG. 5 is a perspective view of the button and the wire according to one embodiment of the present disclosure;

FIG. 6 is another perspective view of the button and the wire according to one embodiment of the present disclosure;

FIG. 7 is a cross-sectional view taken along line VII-VII of FIG. 5; and

FIG. 8 is a cross-sectional view taken along line VIII-VIII of FIG. 5.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### Embodiments

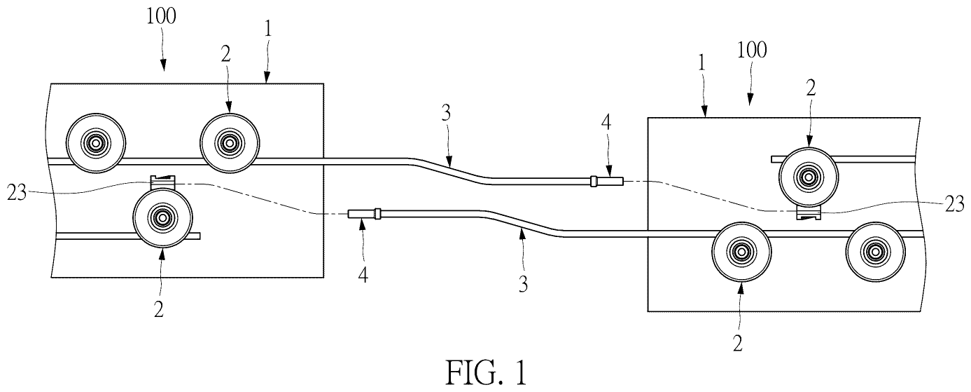

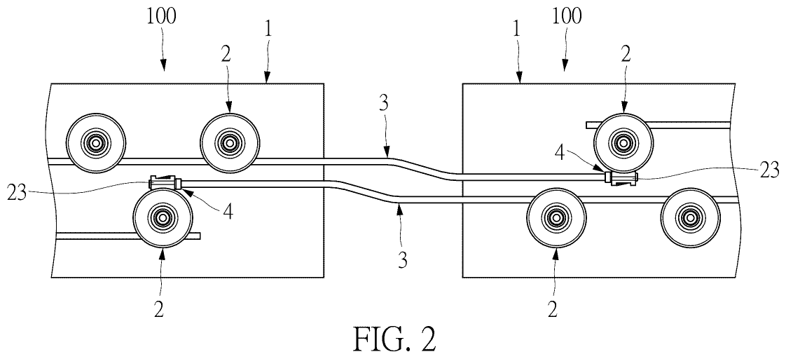

Referring to FIG. 1 and FIG. 2, the present disclosure provides a button-type connection device. The button-type connection device includes two button sets 100, and each of the button sets 100 includes a substrate 1 and a plurality of buttons 2. Preferably, the substrate 1 is flexible, and the plurality of buttons 2 are disposed on the substrate 1. The plurality of buttons 2 are connected by at least one wire 3, such that the plurality of buttons 2 in each of the button sets 100 can be in conduction with each other.

The plurality of buttons 2 are disposed on the substrate 1 of each of the button sets 100. The arrangement of the plurality of buttons 2 is not limited, and can be flexibly changed according to requirements. The plurality of buttons 2 are connected by the wire 3. Each of the button sets 100 can include one or more of the wire 3, and the quantity of the wire 3 is not limited. The wire 3 passes through the plurality of buttons 2, such that the plurality of buttons 2 are electrically connected to each other, and electrical signals can be transmitted to the plurality of buttons 2. Accordingly, the electrical signals can be further transmitted to other devices through the plurality of buttons 2.

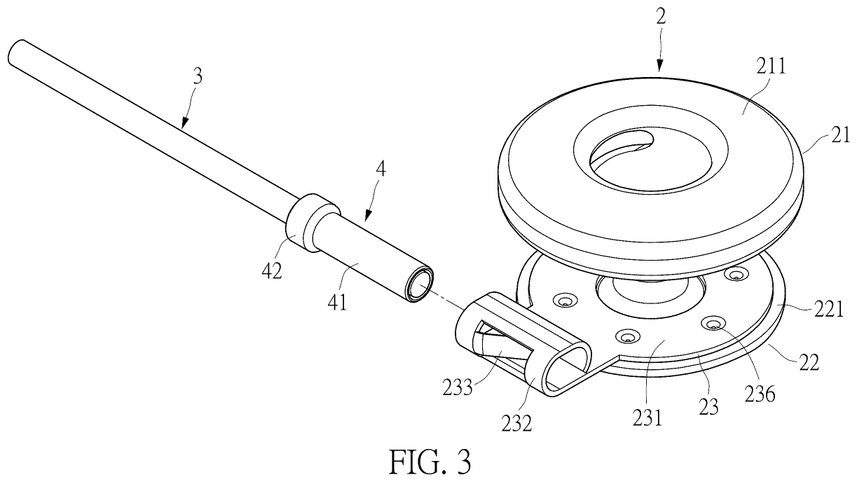

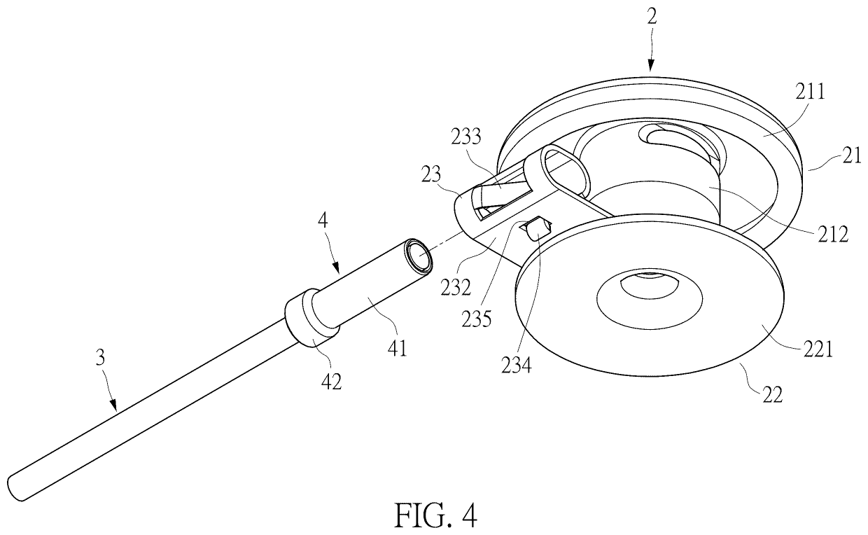

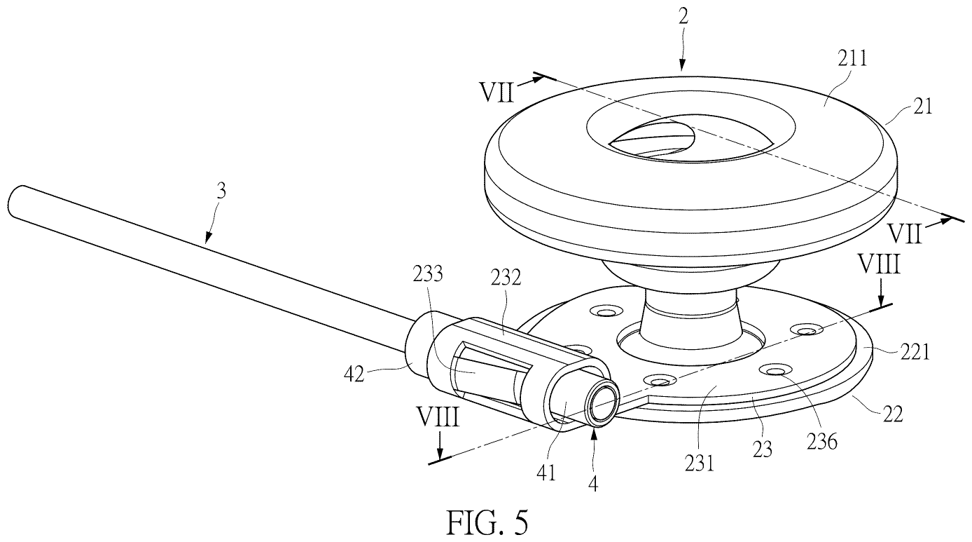

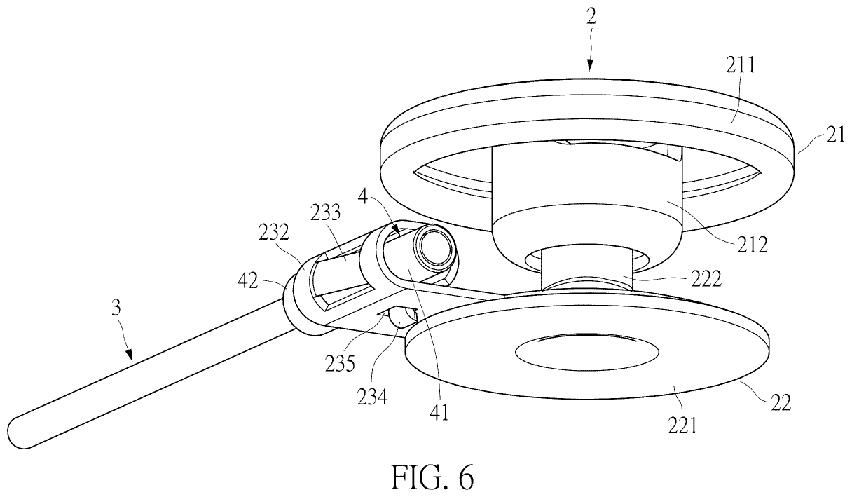

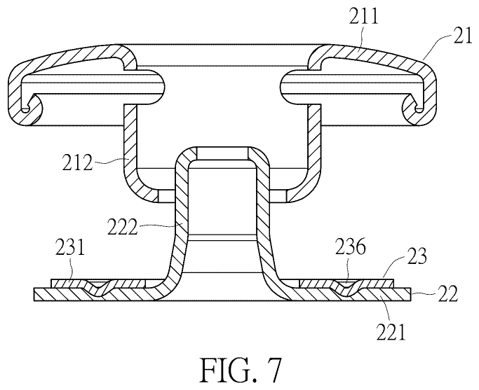

Referring to FIG. 3 to FIG. 6, each of the buttons 2 has a first member 21 and a second member 22. The first member 21 and the second member 22 are made of a metal material having good electrical conductivity (such as copper alloy). The first member 21 is disposed above the second member 22. The first member 21 and the second member 22 are combined, and the first member 21 and the second member 22 can be engaged with and fixed on the substrate 1. The wire 3 passes between the first member 21 and the second member 22, and is electrically connected to the first member 21 and the second member 22. As shown in FIG. 7, in this embodiment, the first member 21 has a first ring 211 and a first column 212. The first column 212 is disposed at a center of the first ring 211. The second member 22 has a second ring 221 and a second column 222. The second column 222 is disposed at a center of the second ring 221. The first ring 211 and the second ring 221 are respectively disposed on opposite sides of the substrate 1, and the second column 222 is fitted into the first column 212, such that each of the buttons 2 can be firmly disposed on the substrate 1.

A connection member 23 is disposed between the first member 21 and the second member 22 of at least one of the plurality of buttons 2 of at least one of the two button sets 100, such that the button 2 can function as a connector. The connection member 23 is made of a metal material having good electrical conductivity (such as copper alloy), such that the connection member 23 has electrical conductivity. The connection member 23 includes a gasket 231 and a slot portion 232. The gasket 231 and the slot portion 232 are connected to each other, and are integrally formed. The gasket 231 may be ring-shaped, and is preferably a circular ring. The gasket 231 may be in contact with the first member 21 or the second member 22, such that the gasket 231 is electrically connected to the first member 21 and the second member 22. The gasket 231 may further include a plurality of anti-slip protrusions 236, and the anti-slip protrusions 236 protrude from one side of the gasket 231. The anti-slip protrusions 236 can be in contact with the first member 21 or the second member 22, and can provide an anti-slip effect to prevent the gasket 231 from rotating. The anti-slip protrusions 236 can further form contact points to increase an electrical conduction effect.

In this embodiment, the gasket 231 is in contact with the second member 22, and the anti-slip protrusions 236 are in contact with the second member 22. In this embodiment, the gasket 231 is a circular ring, and the second ring 221 of the second member 22 is also a circular ring, such that the gasket 231 can match the second ring 221 of the second member 22. Preferably, the gasket 231 and the second ring 221 of the second member 22 are disposed to form concentric circles, such that the gasket 231 can be stably disposed on the second ring 221 of the second member 22.

In this embodiment, one end of the slot portion 232 is connected to an outer edge of the gasket 231, and the slot portion 232 is bent and extends to have a cylindrical shape. Another end of the slot portion 232 is a free end and has a snap portion 234, and a snap hole 235 is formed on the slot portion 232 near the one end. The snap portion 234 can be snapped into the snap hole 235, so as to prevent the slot portion 232 from extending outward and from deformation. A contact arm 233 may be disposed on the slot portion 232, and is inclined toward an inside of the slot portion 232.

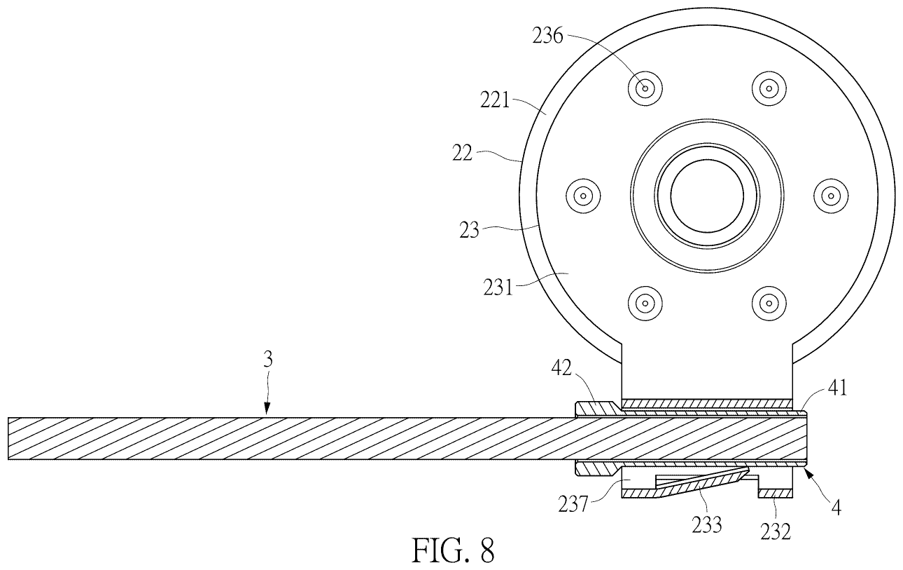

A terminal 4 is disposed at one end of the at least one wire 3 of at least another one of the two button sets 100. The terminal 4 is made of a metal material having good electrical conductivity (such as copper alloy). The terminal 4 is in contact and conduction with the wire 3. That is, the terminal 4 can be in conduction with a core wire inside the wire 3, such that the terminal 4 and the wire 3 are electrically connected. The terminal 4 can be inserted into the slot portion 232, such that the terminal 4 and the connection member 23 are in contact and conduction, and the wire 3 can be electrically connected to the button 2 through the terminal 4. The terminal 4 and the connection member 23 cooperate with each other to outwardly transmit the electrical signal. Furthermore, through a connection terminal formed by the structure of the terminal 4 and the connection member 23, the terminal 4 can be used for connection in subsequent processes. Preferably, an opening 237 (as shown in FIG. 8) may be formed on one side of the slot portion 232, and the opening 237 faces a position between the two button sets 100 to facilitate insertion of the terminal 4, such that the terminal 4 can be quickly inserted into the slot portion 232 through the opening 237.

In this embodiment, the terminal 4 has a terminal body 41, which can be a hollow cylinder for accommodating the at least one wire 3. Preferably, the terminal body 41 is a cylinder, and one end of the terminal body 41 can be connected to a stopper 42. An outer diameter of the stopper 42 is larger than an outer diameter of the terminal body 41. Therefore, when the terminal body 41 is inserted into the slot portion 232, the stopper 42 can abut against and be positioned at one end of the slot portion 232, thereby enabling the terminal 4 and the connection member 23 to be stably positioned. The contact arm 233 abuts against the terminal 4 (as shown in FIG. 8). The contact arm 233 can abut against the terminal body 41 of the terminal 4 to ensure contact and conduction between the terminal 4 and the connection member 23, such that the wire 3 can be electrically connected to the button 2 through the terminal 4.

### Beneficial Effects of the Embodiments

In conclusion, one of the beneficial effects of the present disclosure lies in that, the button-type connection device provided by the present disclosure includes two button sets, and each of the two button sets includes a substrate and a plurality of buttons. The plurality of buttons are disposed on the substrate, and the plurality of buttons of each of the two button sets are connected by at least one wire. Each of the plurality of buttons has a first member and a second member, and the first member and the second member are combined to be fixed on the substrate. A connection member is disposed between the first member and the second member of at least one of the plurality of buttons of at least one of the two button sets. The connection member includes a gasket and a slot portion. The gasket is electrically connected to the first member and the second member. A terminal is disposed at one end of the at least one wire of at least another one of the two button sets, the terminal is in contact and conduction with the at least one wire, and the terminal is inserted into the slot portion to be in contact and conduction with the connection member, so that the at least one wire can be electrically connected to the button through the terminal, and the two button sets achieve electrical connection. The button-type connection device of the present disclosure can quickly connect the two button sets, facilitate connection of the two button sets, and retain a bending property. The button sets are modularly designed, and can be disposed separately. When some of the button sets are damaged, these button sets can be replaced individually, thereby reducing maintenance costs. The button-type connection device can be easily bent and disposed on items that need to be bent, thereby having improved applicability.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A button-type connection device, comprising two button sets, wherein each of the two button sets includes:
a substrate; and
a plurality of buttons, wherein the plurality of buttons are disposed on the substrate, and the plurality of buttons of each of the two button sets are connected by at least one wire, and wherein each of the plurality of buttons has a first member and a second member, and the first member and the second member are combined to be fixed on the substrate;
wherein a connection member is disposed between the first member and the second member of at least one of the plurality of buttons of at least one of the two button sets, the connection member is electrically conductive, and the connection member includes a gasket and a slot portion; wherein the gasket and the slot portion are connected to each other, and the gasket is electrically connected to the first member and the second member; wherein a terminal is disposed at one end of the at least one wire of at least another one of the two button sets, the terminal is in contact and conduction with the at least one wire, and the terminal is inserted into the slot portion to be in contact and conduction with the connection member, so that the two button sets achieve electrical connection.

2. The button-type connection device according to claim 1, wherein the first member has a first ring and a first column, and the first column is disposed at a center of the first ring; wherein the second member has a second ring and a second column, and the second column is disposed at a center of the second ring; and wherein the first ring and the second ring are respectively disposed on opposite sides of the substrate, and the second column is fitted into the first column.

3. The button-type connection device according to claim 2, wherein the gasket is a circular ring, and the second ring of the second member is a circular ring, so that the gasket matches the second ring of the second member.

4. The button-type connection device according to claim 3, wherein the gasket and the second ring of the second member are disposed to form concentric circles.

5. The button-type connection device according to claim 1, wherein one end of the slot portion is connected to an outer edge of the gasket, and the slot portion is bent and extends to have a cylindrical shape; wherein another end of the slot portion is a free end, and has a snap portion; and wherein a snap hole is formed on the slot portion near the one end, and the snap portion is snapped into the snap hole.

6. The button-type connection device according to claim 1, wherein a contact arm is disposed on the slot portion, the contact arm is inclined toward an inside of the slot portion, and the contact arm abuts against the terminal.

7. The button-type connection device according to claim 1, wherein the terminal has a terminal body, and the terminal body is a hollow cylinder for accommodating the at least one wire; and wherein one end of the terminal body is connected to a stopper, an outer diameter of the stopper is larger than an outer diameter of the terminal body, the terminal body is inserted into the slot portion, and the stopper abuts against and is positioned at one end of the slot portion.

8. The button-type connection device according to claim 1, wherein the gasket includes a plurality of anti-slip protrusions, the plurality of anti-slip protrusions protrude from one side of the gasket, and the plurality of anti-slip protrusions are in contact with the first member or the second member.

9. The button-type connection device according to claim 1, wherein the gasket and the slot portion are integrally formed and connected to each other.

10. The button-type connection device according to claim 1, wherein an opening is formed on one side of the slot portion, the opening faces a position between the two button sets, and the terminal is inserted into the slot portion through the opening.
